(19) United States
(12) Patent Application Publication
(10) Pub. No.: US 2009/0278639 A1
(43) Pub. Date: Nov. 12, 2009

(54) CONTROL SWITCH FOR CONTROLLING MAGNETIC LINE OF FORCE

(76) Inventor: LI-MING CHAO, Taipei City (TW)

Correspondence Address: YU-CHIN LEE, P.O.BOX 26-757, TAIPEI, 106, omitted

(21) Appl. No.: 12/436,769

(22) Filed: May 6, 2009

(30) Foreign Application Priority Data
May 9, 2008 (TW) 97208083

(51) Int. Cl. H01H 36/00

(52) U.S. Cl. 335/207

(57) ABSTRACT

A control switch for controlling magnetic line of force is applied to a switch of an electronic equipment or an electrical equipment. The control switch includes a controlled switch, a control part, a first magnetic element, and a second magnetic element. The control switch is located in the housing of the electronic equipment or the electrical equipment. The control switch is electrically connected with the circuit loop of the electronic equipment or the electrical equipment. The control part is located on the exterior of the housing and is movable. The first magnetic element is installed on the control part. The second magnetic element is movably installed in the housing. The second magnetic element corresponds to the contact flake of the controlled switch. The first magnetic element and the second magnetic element can selectively generate a magnetic line of force reaction.

### BACKGROUND OF THE INVENTION

1. Field of the Invention

The present invention relates to a control switch for controlling magnetic line of force; in particular, the present invention relates to a control switch that is applied to electronic equipments or electrical equipments such as a flashlight, a headlamp, a bicycle lamp, an electric switch, or a laser target equipment for controlling the on or off of the power thereof.

2. Description of Related Art

Flashlights or headlamps are one kind of lighting equipment for lighting when guards are patrolling, occurrence of power failure, or conditions of darkness. The flashlights and headlamps usually use a dry cell or a battery as the power source to prevent the flashlights and headlamps from being affect by power outages, so as to meet the requirements for sudden or emergency usage.

In order to meet the requirement of being water-proof, the housing of the flashlights is designed as a structure without through holes, subsequently an induction switch (such as a magnet spring switch) is used to control the turning on or off of the circuit, and thereby achieve the water-proof effect. A flashlight structure of the prior art that can generate electric power by itself, store power, and has a water-proof function typically includes a flashlight housing, a lamp head cover installed with a lens that is pervious to light, an enclosed ring, a switch device, and a tube body sleeved in the flashlight housing. The tube body is installed with a lighting lamp, a circuit board, a battery, a magnetic that can generate power, and an induction coil. The flashlight housing is molded into one piece. One end of the flashlight housing is enclosed, and another end has an opening. Exception for the opening, the flashlight housing has no other through holes. The switch device has a push button that can be shifted for a distance. In the push button, there is a magnetic element. The circuit board has an induction switch that control the turning on or off of the circuit. By adjusting the push button so that the magnetic element and the induction switch are located at the same horizontal level line, and thereby the conduction for the circuit of the circuit board occurs. When the magnetic element departs from the induction switch, the conduction for the circuit of the circuit board is cut. Thereby, the effects of generating power by itself, storing power, and being water-proof are achieved.

The aforementioned conventional flashlight needs to use the magnetic spring switch to control the turning on or off of the circuit. Because the magnetic spring switch is composed of a glass shell and two spring flakes, and the flashlight may be pumped or oscillated when the flashlight is carried or used, the glass shell is easily broken and furthermore the two spring flakes may be shifted and thus become displaced to the wrong locations. Therefore, the magnetic spring switch may be damaged, and fails to operate. Moreover, the magnetic spring switch is easily interfered by the external magnetic element and subsequently leading to erroneous operations.

Furthermore, the magnetic spring switch can merely be applied with a limited amount of current due to the current effect at the connection point. Specifically, when a large amount of current is applied, the connection point of the two spring flakes is easily melted and carbonized so that the magnetic spring switch is damaged and thus fails to operate. Therefore, only those light sources that requires limited amount of current, such as LEDs, can be used in the flashlight. While other light sources that require larger amount of current are thereby limited in terms of current flow. On the other hand, if the circuit of the light equipment itself is changed to compensate for those light sources that require a larger amount of current, then the cost subsequently increases.

### SUMMARY OF THE INVENTION

One particular aspect of the present invention is to provide a control switch for controlling magnetic line of force. It does not require a magnetic spring switch. The problems of the glass shell of the magnetic spring switch being broken, the spring flake being shifted and displaced to the wrong location, and the magnetic spring switch being interfered by a magnetic element and subsequently leading to erroneous operations are solved. The control switch is not easily damaged, does not fail easily, and it can be applied with those electronic elements that needs limited amount of current or larger amount of current. Thereby the electronic elements can be flexibly selected. The control circuit does not need to be changed, so the cost associated with the control circuit is not increased. The inner and outer wall of the housing does not require through hole for moving the control part.

The control switch for controlling magnetic line of force is located on an electronic equipment or an electrical equipment. The electronic equipment or the electrical equipment has a housing, an electronic element, and a circuit loop located on the housing. The control switch includes a controlled switch located in the housing, a control part located on the exterior of the housing and the control part is movable, a first magnetic element located on the control part, and a second magnetic element movably installed in the housing. The controlled switch is electrically connected with the circuit loop of the electronic equipment or the electrical equipment, and has a contact flake. The second magnetic element corresponds to the contact flake of the controlled switch. The first magnetic element and the second magnetic element can selectively generate a magnetic line of force reaction.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is an exploded perspective view of a control switch in accordance to the first embodiment of the present invention;

FIG. 2 is an assembly perspective view of the control switch in accordance to the first embodiment of the present invention;

FIG. 3 is a vertical cross-sectional view of the control switch being conducted in accordance to the first embodiment of the present invention;

FIG. 4 is a horizontal cross-sectional view of the control switch being conducted in accordance to the first embodiment of the present invention;

FIG. 5 is a vertical cross-sectional view of the control switch with the conduction being cut in accordance to the first embodiment of the present invention;

FIG. 6 is a vertical cross-sectional view of the control switch being conducted in accordance to the second embodiment of the present invention;

FIG. 7 is a vertical cross-sectional view of the control switch with conduction being cut in accordance to the third embodiment of the present invention;

FIG. 8 is a vertical cross-sectional view of the control switch with conduction being cut in accordance to the fourth embodiment of the present invention;

FIG. 9 is an exploded perspective view of the control switch of the fifth embodiment in accordance to the present invention;

FIG. 10 is an assembly perspective view of the control switch of the fifth embodiment in accordance to the present invention;

FIG. 11 is a vertical cross-sectional view of the control switch with conduction being cut in accordance to the fifth embodiment of the present invention;

FIG. 12 is a horizontal cross-sectional view of the control switch with conduction being cut in accordance to the fifth embodiment of the present invention;

FIG. 13 is a vertical cross-sectional view of the control switch being conducted in accordance to the fifth embodiment of the present invention;

FIG. 14 is a horizontal cross-sectional view of the control switch being conducted in accordance to the fifth embodiment of the present invention;

FIG. 15 is a horizontal cross-sectional view of the control switch being conducted and positioned in accordance to the fifth embodiment of the present invention;

FIG. 16 is an exploded perspective view of the control switch in accordance to the sixth embodiment of the present invention; and

FIG. 17 is an exploded perspective view of the control switch in accordance to the seventh embodiment of the present invention.

### DETAILED DESCRIPTION OF THE PREFERRED EMBODIMENTS

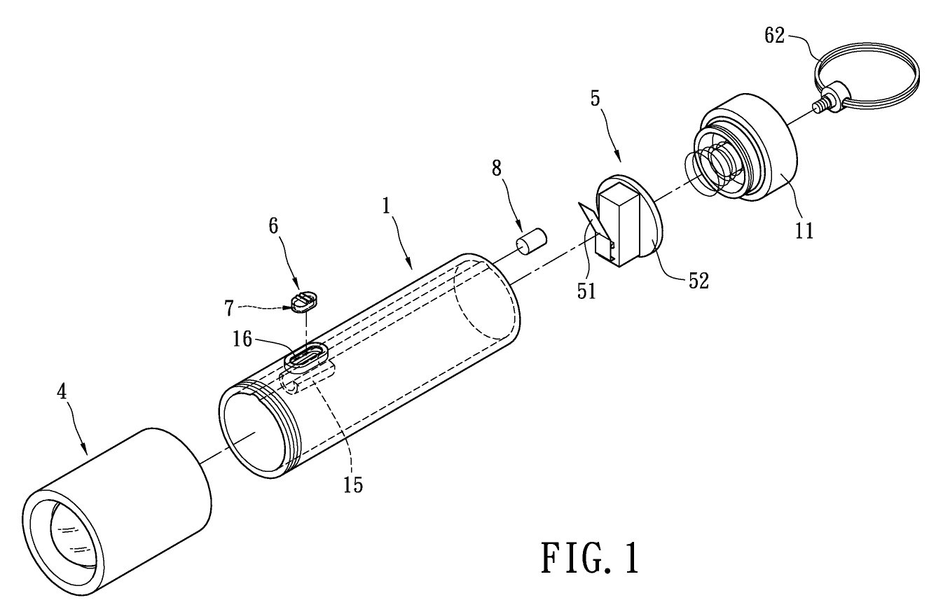

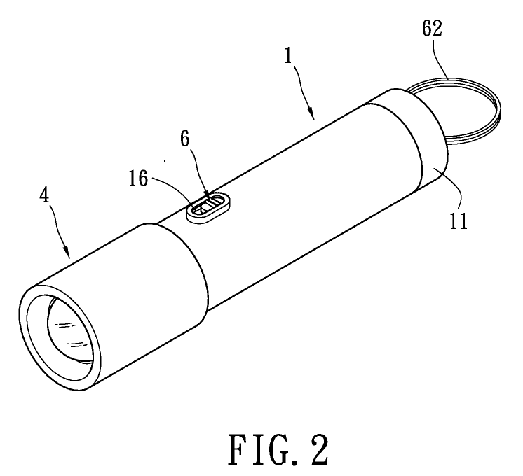

Reference is made to FIGS. 1-4. The control switch for controlling magnetic line of force is applied to a flashlight, a headlamp, a bicycle lamp, an electric switch, or a laser target equipment for controlling the turning of on or off for electronic element (such as a light source). In this embodiment, the electronic equipment or the electrical equipment is a flashlight. The flashlight has a housing 1, a light source 2, and an electric power 3. The housing 1 is a hollow shell, and its outline is not limited to a specific one. The front side of the housing 1 is located with a lamp head cover 4. The lamp head cover 4 is connected with the front side of the housing 1. The rear side of the housing 1 is attached with a rear cover 11 by screw. The rear cover 11 uses the outer screw thread 12 in combination with the inner screw thread 13 located on the inner wall of the rear side of the housing 1, so that the rear cover 11 is connected with the rear side of the housing 1 for enclosing the opening of the rear side of the housing 1. The rear cover 11 is also connected with a key ring 62. There is one or a plurality of sealed rings between the inner wall of the housing 1 and the outer wall of the rear cover 11 for full enclosure.

The light source 2 is a lamp, LED, or laser diode. The light source 2 is located at the front side of the housing 1, and is located in the lamp head cover 4 so that the light source 2 emits light beam forwards via the lamp head cover 4. The electric power 3 is located in the housing 1. The electric power 3 is a dry cell or a battery. The electric power 3 and the light source 2 form a circuit loop via the housing 1 and some conducting elements (not shown in the figure) so that the electric power of the electric power 3 is transmitted to the light source 2. The structure of the flashlight is the same as the prior art, and is not the scope of the present invention. Furthermore, the present invention also is not limited to the flashlight. The structure of the flashlight is not illustrated in detail.

The control switch of the present invention is located on an electronic equipment or an electric equipment for controlling the circuit loop of the electronic equipment, or for controlling the turning of on or off of the electric equipment. The control switch includes a controlled switch 5, a control part 6, a first magnetic element 7, and a second magnetic element 8. The controlled switch 5 is located in the housing 1. The controlled switch 5 is electrically connected with the circuit loop of the electronic equipment or the electric equipment. In this embodiment, the controlled switch 5 is a micro-switch that is fastened and electrically connected with a circuit board 52 so that the controlled switch 5 is electrically connected with the circuit loop of the electronic equipment or the electric equipment by utilizing the circuit board 52, and furthermore the controlled switch 5 is fastened in the housing 1. The controlled switch 5 has a contact flake 51. By pressing or releasing the contact flake 51, the control for turning on or off for the circuit loop of the electronic equipment or the electric equipment is achieved. Alternatively, the controlled switch 5 can also be a micro-switch, an electric connection point, or other types of switch.

The control part 6 is movably located at the outside of the housing 1. In this embodiment, the control part 6 is a push button that is located on the housing 1 and can be slide forwards and backwards. The outside of the housing 1 has a guiding slot 16 for guiding the control part 6 to move forwards and backwards.

The first magnetic element 7 is a magnet or an iron part. The first magnetic element 7 is installed at the inner side of the control part 6. The first magnetic element 7 is located outside of the housing 1. The first magnetic element 7 can move forwards and backwards by utilizing the control part 6.

The second magnetic element 8 is movably installed in the housing 1, and corresponds to the contact flake 51 of the controlled switch 5. The second magnetic element 8 is a magnet or an iron part. There is a guiding track between the second magnetic element 8 and the housing 1 for guiding the second magnetic element 8 to smoothly slide forwards and backwards. One side surface of the second magnetic element 8 that is adjacent to the first magnetic element 7 is a magnetic pole that is the same as or different from the first magnetic element 7. In this embodiment, the magnetic pole of the second magnetic element 8 that is adjacent to the first magnetic element 7 is the same as the first magnetic element 7 so that the magnetic lines of force between the second magnetic element 8 and the first magnetic element 7 repel against each other

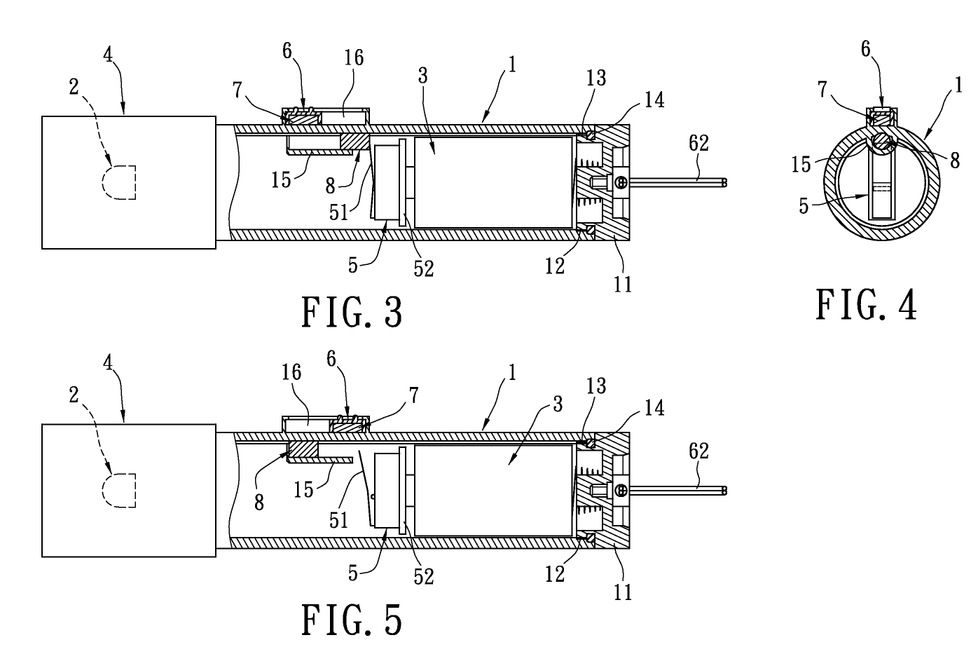

In this embodiment, by moving the control part 6 forwards and backwards to make the magnetic line of force of the first magnetic element 7 repels against the magnetic line of force of the second magnetic element 8, the second magnetic element 8 move forwards and backwards. When the control part 6 makes the repelled magnetic line of force of the first magnetic element 7 push the second magnetic element 8 to move forwards the controlled switch 5 (moves backwards), then subsequently the second magnetic element 8 contacts the contact flake 51 of the controlled switch 5 (as shown in FIG. 3) and thereby controls the circuit loop of the electronic equipment or the electric equipment to become conducted so that the light source 2 lights up.

When the control part 6 makes the repelled magnetic line of force of the first magnetic element 7 push against the second magnetic element 8, so that the second magnetic element 8 departs from the controlled switch 5 (moves forwards), then subsequently the second magnetic element 8 releases the contact flake 51 of the controlled switch 5 (as shown in FIG. 5), and thereby controls the circuit loop of the electronic equipment or the electric equipment to be turned off so that the light source 2 is turned off.

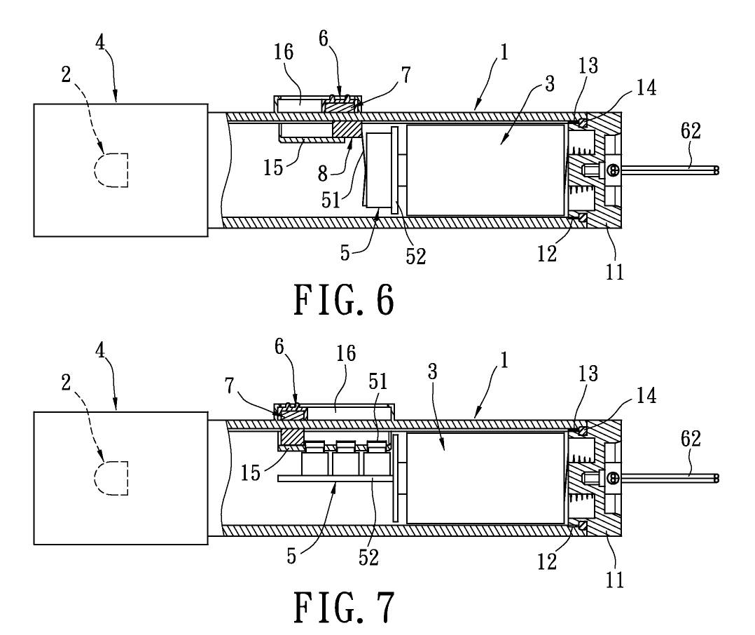

Reference is made to FIG. 6. In this embodiment, the magnetic poles between the second magnetic element 8 and the first magnetic element 7 are different so that the magnetic lines of force between the second magnetic element 8 and the first magnetic element 7 attract each other. In this embodiment, by moving the control part 6 forwards and backwards, the first magnetic element 7 subsequently attracts the second magnetic element 8 to move forwards and backwards. When the control part 6 makes the first magnetic element 7 to attract the second magnetic element 8 to move towards the controlled switch 5 (specifically, moving backwards), the second magnetic element 8 contacts the contact flake 51 of the controlled switch 5, and thereby controls the circuit loop of the electronic equipment or the electric equipment to become conducted so that the light source 2 lights up.

When the control part 6 makes the first magnetic element 7 attract the second magnetic element 8, so that the second magnetic element 8 depart from the controlled switch 5 (specifically, moving forwards), the second magnetic element 8 releases the contact flake 51 of the controlled switch 5, and thereby subsequently controls the circuit loop of the electronic equipment or the electric equipment to be turned off so that the light source 2 is turned off.

Reference is made to FIG. 7. In this embodiment, the magnetic lines of force between the second magnetic element 8 and the first magnetic element 7 attracts with each other, and there are a plurality of controlled switches 5 between the second magnetic element 8 and the first magnetic element 7. The controlled switches 5 can be used for different control circuits (such as body guard electrical shocker, brightness, or light color, etc.) to the light source 2, wherein the light source 2 can be installed with two or more than two loading circuits. In this embodiment, by moving the control part 6 forwards and backwards so that the first magnetic element 7 attracts with the second magnetic element 8, then subsequently the second magnetic element 8 move forwards and backwards to contact or release the contact flake 51 of the controlled switch 5.

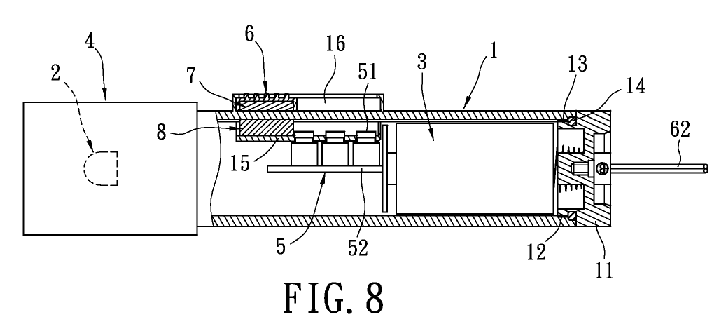

Reference is made to FIG. 8. In this embodiment, the magnetic poles between the second magnetic element 8 and the first magnetic element 7 are different so that the magnetic lines of force between the second magnetic element 8 and the first magnetic element 7 attract with each other, and there are a plurality of controlled switches 5 between the second magnetic element 8 and the first magnetic element 7. The controlled switches 5 can be used for different control circuits (such as body guard electrical shocker, brightness, or light color, etc.) to the light source 2, wherein the light source 2 can be installed with two or more than two loading circuits. In this embodiment, by moving the control part 6 forwards and backwards so that the first magnetic element 7 attract the second magnetic element 8, then subsequently the second magnetic element 8 move forwards and backwards to contact or release the contact flake 51 of the controlled switch 5.

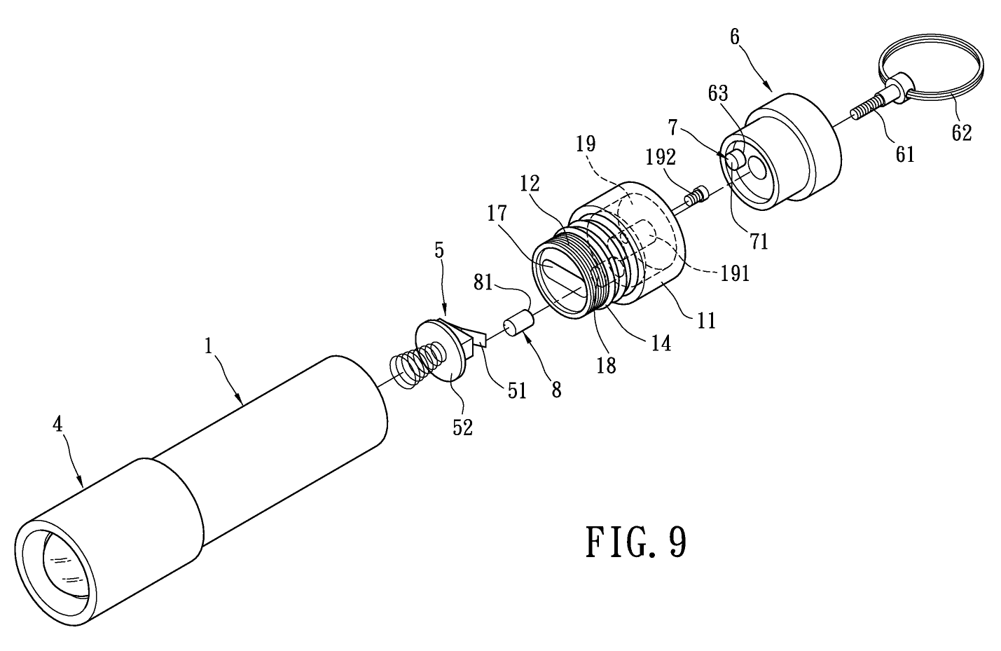

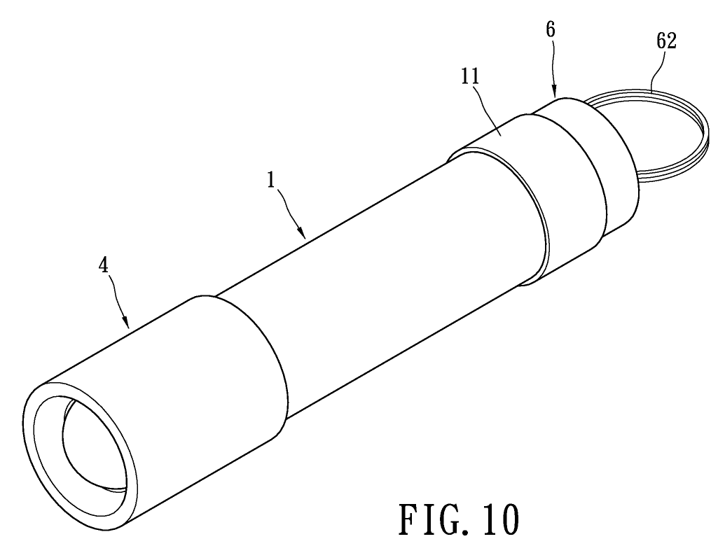

Reference is made to FIGS. 9-13. In this embodiment, the control part 6 is rotatably located at the rear cover 11 of the housing 1. The front side of the rear cover 11 has a first receiving space 17 that corresponds to the controlled switch 5. The controlled switched 5 is received in the first receiving space 17. The rear side of the first receiving space 17 has a moving slot 18. The moving slot 18 is not located at the center of the rear cover 11. The front side of the moving slot 18 links the rear side of the first receiving space 17. The rear side of the rear cover 11 has a second receiving space 19. In the second receiving space 19, there is a screw hole column 191 and a blocking part 192. The screw hole column 191 is located at the center of the rear cover 11, and the blocking part 192 is not located at the center of the rear cover 11. The front portion of the control part 6 is rotatably plugged in the second receiving space 19 so that the control part 6 is rotatably located on the rear cover 11 of the housing 1, and is screwed with the screw hole column 191 of the rear cover 11 via passing a screw 61 through the center of the control part 6. Thereby, the control part 6 is rotatably positioned on the rear cover 11 of the housing 1. Therein, the screw 61 is connected with a key ring 62.

The first magnetic element 7 is a magnet. The first magnetic element 7 is fixedly installed in the fixed trough 63 located at the front side of the control part 6 and is not at the center. One side surface of the first magnetic element 7 extends into the second receiving space 19 of the rear cover 11 of the housing 1. The first magnetic element 7 can be rotated by the control part 6.

The second magnetic element 8 is a magnet. The second magnetic element 8 is movably installed in the moving slot 18 of the rear cover 11 of the housing 1, and corresponds to the contact flake 51 of the controlled switch 5. The side surfaces 81, 71 of the second magnetic element 8 and the first magnetic element 7 that are adjacent to each other have the same magnetic polarity so that the second magnetic element 8 repels against the first magnetic element 7.

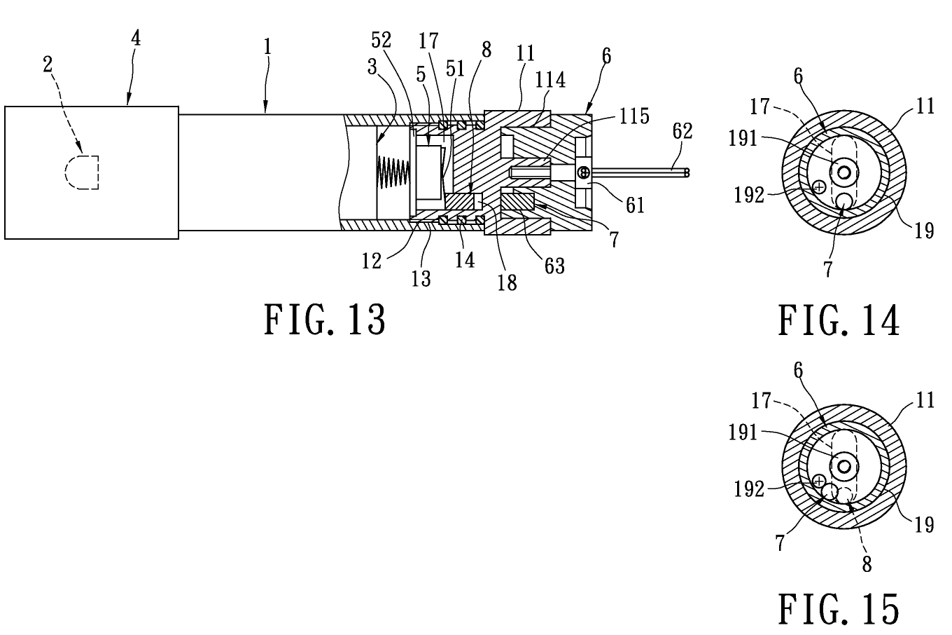

In this embodiment, by rotating the control part 6, the first magnetic element 7 and the second magnetic element 8 are moved, so that the first magnetic element 7 and the second magnetic element 8 becomes either corresponding to each other or depart from each other. When the control part 6 makes the first magnetic element 7 correspond with the second magnetic element 8 (as shown in FIG. 13 and FIG. 14), then subsequently the first magnetic element 7 repels against the second magnetic element 8 and pushes the second magnetic element 8 to move forward to the controlled switch 5 (forwards); wherein, the second magnetic element 8 then presses the contact flake 51 of the controlled switch 5 to control the circuit loop of the electronic equipment or the electric equipment to become conducted so that the light source 2 is turned on. When the control part 6 is continuously rotated, the first magnetic element 7 eventually contacts the blocking element 192, wherein the blocking element 192 is for blocking and positioning the first magnetic element 7 and the control part 6 (as shown in FIG. 15).

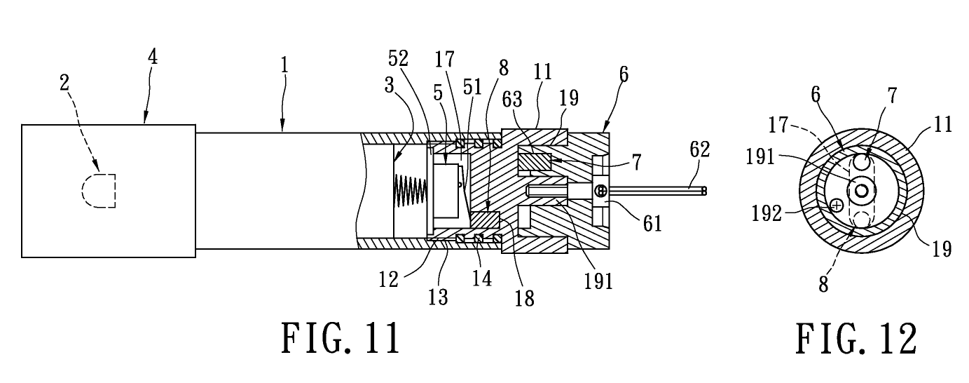

When the control part 6 makes the first magnetic element 7 departs from the second magnetic element 8 for a proper distance (as shown in FIG. 11 and FIG. 12), the repelled force between the first magnetic element 7 and the second magnetic element 8 becomes weaker. Subsequently, the second magnetic element 8 is pushed forward to the direction that departs from the controlled switch 5 (backwards) by the flexible force of the contact flake 51. Thereby, the second magnetic element 8 releases the contact flake 51 of the controlled switch 5, and thereby subsequently controls the circuit loop of the electronic equipment or the electric equipment to be cut so that the light source 2 is turned off.

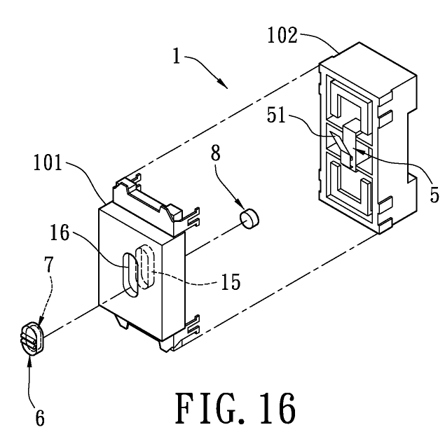

Reference is made to FIG. 16. In this embodiment, the electronic equipment or the electric equipment is an electric switch. The electronic equipment or the electric equipment has a housing 1, electronic elements, electric device, and circuit loop (not shown in the figure) that is located in the housing 1. The housing 1 includes a cover body 101 and a base body 102. The controlled switch 5 is located in the housing 1. The controlled switch 5 is electrically connected with the circuit loop of the electronic equipment or the electric equipment. The controlled switch 5 has a contact flake 51. The control part 6 is movably located in the guiding slot 16 that is located outside of the cover body 101 of the housing 1. The first magnetic element 7 is installed on the control part 6. The second magnetic element 8 is movably located in the guiding slot 15 that is located in the housing 1. The second magnetic element 8 corresponds to the contact flake 51 of the controlled switch 5. The first magnetic element 7 and the second magnetic element 8 can selectively generate corresponding magnetic line of force so that the second magnetic element 8 may contact with the controlled switch 5 so as to control the turning on or off of the circuit loop.

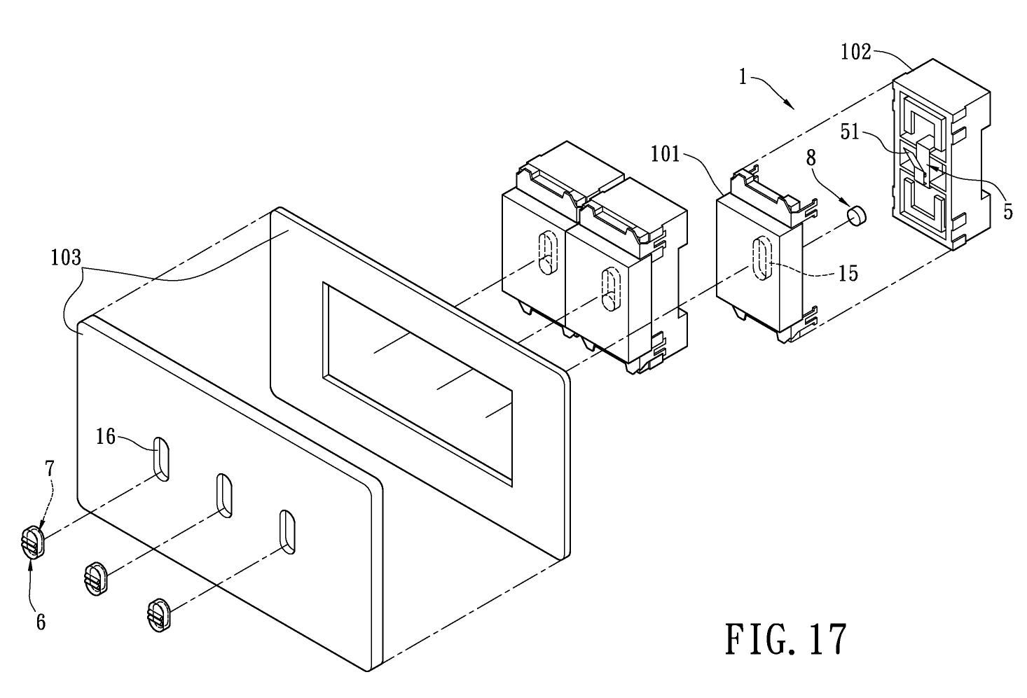

Reference is made to FIG. 17. In this embodiment, the electronic equipment or the electric equipment is an electric switch. The electronic equipment or the electric equipment has a housing 1, electronic elements, and circuit loop (not shown in the figure) that is located in the housing 1. The housing 1 includes a cover body 101, a base body 102, and a switch panel 103. The controlled switch 5 is located in the housing 1. The controlled switch 5 is electrically connected with the circuit loop of the electronic equipment or the electric equipment. The controlled switch 5 has a contact flake 51. The control part 6 is movably located in the guiding slot 16 that is located outside of the switch panel 103 of the housing 1. The first magnetic element 7 is installed on the control part 6. The second magnetic element 8 is movably located in the guiding slot 15 that is located in the housing 1. The second magnetic element 8 corresponds to the contact flake 51 of the controlled switch 5. The first magnetic element 7 and the second magnetic element 8 can selectively generate corresponding magnetic line of force so that the second magnetic element 8 may contact with the controlled switch 5 so as to control the turning on or off of the circuit loop.

The present invention utilizes the control part 6 to move the first magnetic element 7 and the second magnetic element 8, and so that the first magnetic element 7 and the second magnetic element 8 can selectively generate corresponding magnetic line of force, and thereby the second magnetic element 8 contact with the controlled switch 5 to control the turning on or off of the circuit loop. The present invention does not need the magnetic spring switch. The present invention uses the controlled switch, other types of switches, or electric connection point. The controlled switch 5 does not have the problems of the glass housing being fragile and breaking, spring flake being shifted, and incorrect displacement of the magnetic spring switch due to shifting. The controlled switch 5 is not easily damaged, nor easily fails. Moreover, the controlled switch 5 can be applied to those electronic elements that operate with small amount of current or larger amount of current (such as light source, electric equipment). Thus, electronic elements can be flexibly selected. The circuit does not need to be changed, so subsequently the cost associated does not increase.

The present invention utilizes the magnetic line f force of the first magnetic element 7 and the second magnetic element 8 that attracts or repel with each other, in order to control the operation of the controlled switch 5. Except for the opening terminal, the housing 1 does not have any through holes. The electronic equipment or the electric equipment can be fully sealed by cooperating with the sealing ring 13. The water-proof capability is good. The electronic equipment or the electric equipment can be applied for diving activity, or a field that requires flame-proof capability.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A control switch for controlling magnetic line of force, located on an electronic equipment or an electrical equipment, wherein the electronic equipment or the electrical equipment has a housing, an electronic element, and a circuit loop that is located on the housing, the control switch comprising:
a controlled switch located in the housing, wherein the controlled switch is electrically connected with the circuit loop of the electronic equipment or the electrical equipment, and has a contact flake;
a control part located on the exterior of the housing and the control part is movable;
a first magnetic element located on the control part; and
a second magnetic element movably installed in the housing, wherein the second magnetic element corresponds to the contact flake of the controlled switch, the first magnetic element and the second magnetic element selectively generate a magnetic line of force reaction.

2. The control switch as claimed in claim 1, wherein the controlled switch is fastened onto and electrically connected with a circuit board, and the circuit board is electrically connected with the circuit loop of the electronic equipment or the electrical equipment.

3. The control switch as claimed in claim 1, wherein the control part is rotatably located on the housing.

4. The control switch as claimed in claim 3, wherein the rear side of the housing is attached with a rear cover by screw, and the control part is rotatably located on the rear cover.

5. The control switch as claimed in claim 4, wherein there is a sealed ring between the housing and the rear cover.

6. The control switch as claimed in claim 4, wherein the rear cover has a first receiving space and a second receiving space, the controlled switch is received in the first receiving space and the control part is rotatably plugged in the second receiving space.

7. The control switch as claimed in claim 6, wherein the rear cover has a moving slot, the moving slot links with the first receiving space, and the second magnetic element is movably installed in the moving slot.

8. The control switch as claimed in claim 6, wherein the second receiving space protrudes to form a screw hole column, a screw passes through the control part and screws the control part with the screw hole column, and the screw is connected with a key ring.

9. The control switch as claimed in claim 6, wherein the second receiving space protrudes to form a blocking part, and the block part is for blocking and positioning the first magnetic element.

10. The control switch as claimed in claim 1, wherein the control part has a fastening slot, and the first magnetic element is fastened in the fastening slot.

11. The control switch as claimed in claim 1, wherein the control part is slidably located on the housing forwards and backwards.

12. The control switch as claimed in claim 1, wherein the first magnetic element and the second magnetic element are magnets.

13. The control switch as claimed in claim 12, wherein the side surfaces of the second magnetic element and the first magnetic element that are adjacent to each other are magnetic poles with different polarity.

14. The control switch as claimed in claim 12, wherein the side surfaces of the second magnetic element and the first magnetic element that are adjacent to each other are magnetic poles with same polarity.

15. The control switch as claimed in claim 1, wherein the first magnetic element is a magnet, and the second magnetic element is an iron part.

16. The control switch as claimed in claim 1, wherein the first magnetic element is an iron part, and the second magnetic element is a magnet.

17. The control switch as claimed in claim 1, wherein the electronic element is a light source.

18. The control switch as claimed in claim 1, wherein the electronic equipment or the electrical equipment is a flashlight, a headlamp, a bicycle lamp, an electric switch, or a laser target equipment.

19. A control switch for controlling magnetic line of force, located on an electronic equipment or an electrical equipment, wherein the electronic equipment or the electrical equipment has a housing, an electronic element, and a circuit loop, the control switch comprising:
a switch located in the housing, wherein the switch is electrically connected with the circuit loop of the electronic equipment or the electrical equipment;
a control part located on the exterior of the housing and the control part is movable;
a first magnetic element installed on the control part; and
a second magnetic element movably installed in the housing, wherein the second magnetic element corresponds to the switch, the first magnetic element and the second magnetic element selectively generate a magnetic line of force reaction.

20. A control switch for controlling magnetic line of force, located on an electronic equipment or an electrical equipment, wherein the electronic equipment or the electrical equipment has a housing, an electronic element, and a circuit loop, the control switch comprising:
an electric connection point located in the housing, wherein the electric connection point is electrically connected with the circuit loop of the electronic equipment or the electrical equipment;
a control part located on the exterior of the housing and the control part is movable;
a first magnetic element located on the control part; and
a second magnetic element movably installed in the housing, wherein the second magnetic element corresponds to the electric connection point, the first magnetic element and the second magnetic element selectively generate a magnetic line of force reaction.
